(19) United States
(12) Patent Application Publication
(10) Pub. No.: US 2018/0376516 A1
(43) Pub. Date: Dec. 27, 2018

(54) Establishing a Datagram Transport Layer Security Connection between Nodes in a Cluster

(71) Applicant: Aruba Networks, Inc., Sunnyvale, CA (US)

(72) Inventor: Vamsi Krishna Bandlamudi, Bangalore (IN)

(21) Appl. No.: 15/629,103

(22) Filed: Jun. 21, 2017

(51) Int. Cl. H04W 76/02; H04L 29/06

(52) U.S. Cl. CPC H04W 76/02; H04L 63/166; H04L 69/164; H04L 69/22

(57) ABSTRACT

Some examples relate to establishing a DTLS connection between nodes in a cluster. In an example, an initiator node in a cluster may send a DTLS message of a first type to a responder node. The DTLS message may include a header comprising: a message type field for identifying a message type, a flag field for identifying a message sender and a message category, an initiator connection ID field for identifying a connection ID allocated by the initiator node, and a responder connection ID field for identifying a connection ID allocated by the responder node. In DTLS message of the first type, the message type may represent a connection initiation request message, the initiator connection ID field may include a connection ID allocated by the initiator node, the responder connection ID field may be set to zero, and flag field may identify the initiator node as message sender.

### BACKGROUND

A cluster may include a set of nodes that communicate with each other and work towards a common goal. A wireless cluster may include a group of nodes (for example, Wireless Access Points (WAPs)) dynamically joined over the same network. A wireless cluster may provide a single point of administration for access points in the same network.

### BRIEF DESCRIPTION OF THE DRAWINGS

For a better understanding of the solution, embodiments will now be described, purely by way of example, with reference to the accompanying drawings, in which:

FIG. 1 is a block diagram of an example computing environment for establishing a DTLS connection between nodes in a cluster;

FIG. 2 is a block diagram of an example header;

FIG. 3 is a block diagram of an example device for establishing a DTLS connection between nodes in a cluster;

FIG. 4 is a block diagram of an example method of establishing a DTLS connection between nodes in a cluster; and

FIG. 5 is a block diagram of an example system including instructions in a machine-readable storage medium for establishing a DTLS connection between nodes in a cluster.

### DETAILED DESCRIPTION

A WAP may connect to a router and serve as a node to a Wireless Local Area Network (WLAN). When multiple WAPs are joined on the same network, they may form a wireless cluster. A cluster may provide a single point of administration, which enables a user to configure just one access point. The remaining access points in the cluster may obtain the configuration details from the first one. Likewise, a change made to the configuration of one access point may be auto-synced to other access points in the cluster.

Multiple nodes (for example, access points) in a cluster may communicate with each other for various purposes, for example, distributed data cache, state synchronization, and configuration synchronization. It may be desirable to secure peer to peer communication between nodes of a cluster in a manner that enables, for example, authentication between communicating peers, key exchange between communicating peers with support for rekeying and re-authentication, protection from replay attacks, and message transport with confidentiality, integrity and origin check. It may be further desirable if such communication allows multiplexing of multiple connections between peer nodes on the same port to enable, for example, graceful transition between connections during rekey and collision resolution.

To address these technical challenges, the present disclosure describes various examples for establishing a DTLS connection between nodes in a cluster. In an example, an initiator node in a cluster may send a Datagram Transport Layer Security (DTLS) message of a first type to a responder node in the cluster. The DTLS message of the first type may include a header comprising: a message type field for identifying a message type, a flag field for identifying a message sender and a message category, an initiator connection ID field for identifying a connection ID allocated by the initiator node, and a responder connection ID field for identifying a connection ID allocated by the responder node. In the DTLS message of the first type, the message type may represent a connection initiation request message, the initiator connection ID field may include a connection ID allocated by the initiator node, the responder connection ID field may be set to zero, and the flag field may identify the initiator node as the message sender.

In response, the initiator node may receive an initiation response message from the responder node. The initiation response message may comprise a header with fields similar to the fields of the header in the DTLS message of the first type. In the initiation response message, the responder connection ID field may include a connection ID allocated by the responder node, and the flag field may identify the responder node as the message sender and a response message as the message category.

The initiator node may then send a DTLS message of a second type to the responder node. The DTLS message of the second type may comprise a header with fields similar to the fields of the header in the DTLS message of the first type. In the DTLS message of the second type, the message type may represent a connection negotiation message, the initiator connection ID field may include the connection ID allocated by the initiator node, and the responder connection ID field may include the connection ID allocated by the responder node.

In response, the initiator node may receive a negotiation response message from the responder node. In the negotiation response message, the flag field may identify the responder node as the message sender and a response message as the message category. A DTLS connection may then be established between the initiator node and the responder node.

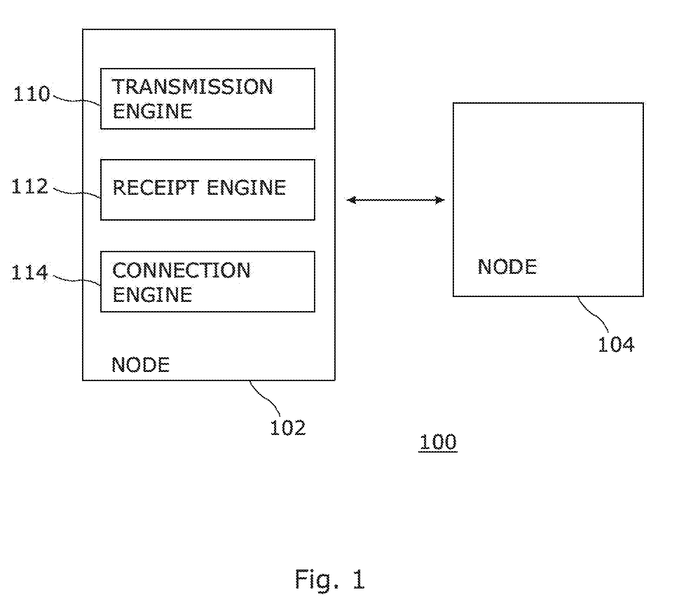

FIG. 1 is a block diagram of an example computing environment 100 for establishing a DTLS connection between nodes in a cluster. In an example, computing environment 100 may include a wireless local area network (WLAN). In an example, the WLAN may include an Institute of Electrical and Electronics Engineers (IEEE) 802.11 WLAN. IEEE 802.11 is a set of media access control (MAC) and physical layer (PHY) specifications for implementing wireless local area network (WLAN) computer communication.

Computing environment 100 may include a plurality of nodes 102 and 104. Although two nodes are shown in FIG. 1, other examples of this disclosure may include more than two nodes. As used herein, the term “node” may refer to any type of computing device capable of reading machine-executable instructions. In an example, nodes 102 and 104 may each include a wireless access point (WAP). A WAP may include a device, such as a wireless router, that allows wireless devices to connect to a network (for example, a WLAN). In an example, nodes 102 and 104 may be members of the same cluster. In another example, nodes 102 and 104 may be members of separate clusters.

In the example of FIG. 1, node 102 may include a transmission engine 110, a receipt engine 112, and a connection engine 114. For the sake of simplicity in illustration, node 102 is shown to include transmission engine 110, receipt engine 112, and connection engine 114. However, any of the other nodes in computing environment 100 (for example, 104) may include transmission engine 110, receipt engine 112, and connection engine 114.

Engines 110, 112 and 114 may include any combination of hardware and programming to implement the functionalities of the engines described herein. In examples described herein, such combinations of hardware and software may be implemented in a number of different ways. For example, the programming for the engines may be processor executable instructions stored on at least one non-transitory machine-readable storage medium and the hardware for the engines may include at least one processing resource to execute those instructions. In some examples, the hardware may also include other electronic circuitry to at least partially implement at least one engine of node 102. In some examples, the at least one machine-readable storage medium may store instructions that, when executed by the at least one processing resource, at least partially implement some or all engines of node 102. In such examples, node 102 may include the at least one machine-readable storage medium storing the instructions and the at least one processing resource to execute the instructions.

In an example, a node (for example, 102) in computing environment 100 may act as an “initiator node”, and another node (for example, 104) may act as a “responder node”. In an example, transmission engine 110 on initiator node 102 may send a DTLS message of a first type to responder node 104. In an example, DTLS message of the first type may represent a connection initiation message for initiating a DTLS connection between initiator node 102 and responder node 104. DTLS message of the first type may represent a first exchange between initiator node 102 and responder node 104 for establishing a DTLS connection between initiator node 102 and responder node 104. In an example, the connection initiation message may be a request-response message.

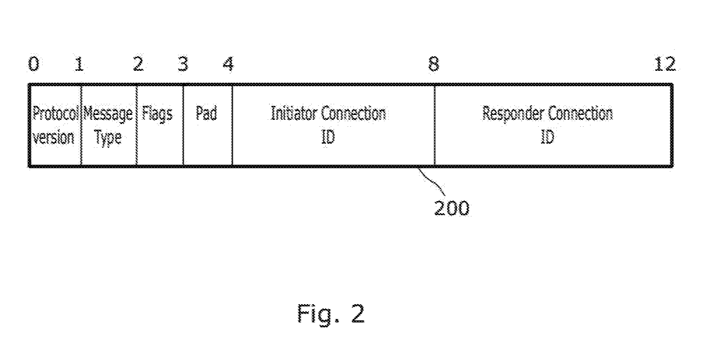

DTLS message of the first type may include a header. FIG. 2 illustrates a block diagram of an example header 200. In an example, the header 200 may include the following fields: a protocol version field for identifying a version of the header, a message type field for identifying a message type, a flag field for identifying a message sender and a message category, a pad field, an initiator connection ID field for identifying a connection ID allocated by initiator node 102, and a responder connection ID field for identifying a connection ID allocated by responder node 104. In an example, the flag field may be set to specify whether a message is from initiator node 102 or responder node 104. For example, a flag MSG_FLAG_INITIATOR may be set to indicate that a message is from initiator node 102. If flag MSG_FLAG_INITIATOR is not set, it may indicate that a message is from responder node 104. The flag field may also be set to identify a message category. The message category may be used to determine whether a message is a request or response message. For example, a flag MSG_FLAG_RESPONSE may be set to indicate that a message is a response message. If flag MSG_FLAG_RESPONSE is not set, it may indicate that a message is a request message. The pad filed may be used for a four-byte alignment.

In an example, in the header, the responder connection ID field may follow the initiator connection ID field; the initiator connection ID field may follow the pad field; the pad field may follow the flag field; the flag filed may follow the message type field; and the message type field may follow the protocol version field.

In an example, the message type in DTLS message of the first type may represent a connection initiation message. In an example, the message type may be represented as MSG_CTRL_CONN_INIT. The initiator connection ID field in DTLS message of the first type may include a connection ID allocated by initiator node 102. The responder connection ID field in DTLS message of the first type may be set to zero. The flag field in DTLS message of the first type may identify initiator node 102 as the message sender. For example, by setting the flag MSG_FLAG_INITIATOR.

In response to receiving DTLS message of the first type from initiator node 102, responder node 104 may generate an initiation response message. In an example, the initiation response message may include a header comprising fields similar to the fields present in the header of DTLS message of the first type. In an example, responder node 104 may allocate a connection ID, and include the connection ID in the responder connection ID field of the header in the initiation response message. Responder node 104 may update the flag field in the header of the initiation response message to identify responder node 104 as the message sender. For example, by not setting the flag MSG_FLAG_INITIATOR.

Responder node 104 may further update the flag field in the header of the initiation response message to identify the initiation response message as a response message. For example, by setting the flag MSG_FLAG_RESPONSE. The remaining fields in the header of the initiation response message may include similar information (for example, connection ID allocated by initiator node 102) as provided in the header of DTLS message of the first type from initiator node 102. Responder node 104 may send the initiation response message to initiator node 102.

In response to receiving the initiation response message from responder node 104, initiator node 102 may identify the connection ID allocated by responder node 104 from the header in the initiation response message. Initiator node 102 may store the connection ID allocated by responder node 104. Initiator node 102 may send a DTLS message of a second type to responder node 104.

In an example, DTLS message of the second type may represent a connection negotiation message for performing a DTLS handshake as described by DTLS protocol. DTLS message of the second type may be used for establishing a DTLS connection between initiator node 102 and responder node 104. In an example, the connection negotiation message may be a request-response message.

DTLS message of the second type may include a header comprising fields similar to the fields present in the header of DTLS message of the first type. In an example, initiator node 102 may update the header in DTLS message of the second type to indicate a connection negotiation message as the message type. In an example, the message type may be represented as MSG_CTRL_CONN_NEGOTIATE. Initiator node 102 may identify the connection ID allocated by responder node 104 from the header in the initiation response message. Initiator node 102 may update the header in DTLS message of the second type to include the connection ID allocated by responder node 104 in the responder connection ID field. The initiator connection ID field in the header of DTLS message of the second type may include the connection ID allocated by initiator node 102. The flag field in DTLS message of the second type may identify initiator node 102 as the message sender. For example, by setting the flag MSG_FLAG_INITIATOR.

In response to receiving DTLS message of the second type from initiator node 102, responder node 104 may generate a negotiation response message. In an example, the negotiation response message may include a header comprising fields similar to the fields present in the header of DTLS message of the first type. In an example, responder node 104 may update the flag field in the header of the negotiation response message to identify responder node 104 as the message sender. For example, by not setting the flag MSG_FLAG_INITIATOR. The remaining fields in the header of the negotiation response message may include similar information as provided in the header of DTLS message of the second type from initiator node 102. Responder node 104 may send the negotiation response message to initiator node 102. A DTLS connection may be established between initiator node 102 and responder node 104 after exchange of connection negotiation messages. In an example, the aforementioned exchange of DTLS messages of first type and second type may be used to establish multiple DTLS connections (for example, a second DTLS connection, a third DTLS connection, and the like) between initiator node 102 and responder node 104.

In an example, the DTLS message of the second type may include a handshake message specified by DTLS protocol. In an example, the DTLS message of the second type may include a ClientHello message specified by DTLS protocol. In an example, negotiation response message may include a HelloVerifyRequest message specified by DTLS protocol.

Initiator node 102 or responder node 104 may send a DTLS message of a third type to responder node 104. DTLS message of the third type may include a header comprising fields similar to the fields present in the header of DTLS message of the first type. In an example, DTLS message of the third type may represent a connection notification message. In an example, the connection notification message may be a close notify DTLS alert message. The alert message may be sent by initiator node 102 or responder node 104 to notify closing of a DTLS connection. It may include the last message sent on a connection. After a close notify alert message, no data may be sent on a connection. Either peer node (for example, initiator node or responder node) may initiate a close notify message.

Initiator node 102 may update the header in the DTLS message of the third type. In an example, the message type in DTLS message of the third type may represent a connection notification message. In an example, the message type may be represented as MSG_CTRL_CONN_NOTIFY. The initiating peer (for example, node 102) may set the request flag. For example, if initiator node 102 initiates the close notify message, initiator node 102 may update the flag field in DTLS message of the third type to identify initiator node 102 as the message sender. For example, by setting the flag MSG_FLAG_INITIATOR. Initiator node 102 may further populate the initiator connection ID field and responder connection ID field in the header with connection IDs allocated by initiator node 102 and responder node 104 respectively. Initiator node 102 may then send DTLS message of the third type to responder node 104. In response, responder node 104 may send a close notify response message, and close its end of the DTLS connection with initiator node 102. After receiving the close notify message from responder node 104, initiator node 102 may close the connection at its end.

Initiator node 102 may send a DTLS message of a fourth type to responder node 104. In an example, responder node 104 may send a DTLS message of a fourth type to initiator node 102. In an example, DTLS message of the fourth type may represent a data exchange message. In an example, the data exchange message may be used for exchanging data between peers (for example, nodes 102 and 104) once a DTLS connection has been established. DTLS message of the fourth type may include a header comprising following fields: a protocol version field for identifying a version of the header, a message type field for identifying a message type, a pad field, and a connection ID field. In an example, the message type in DTLS message of the fourth type may represent a data exchange message. In an example, the message type may be represented as MSG_DATA. The pad field may be used for a four-byte alignment. The connection ID field may be filled with a connection ID of the node (for example, initiator node 102 or responder node 104) to which the data is to be sent. The sending peer may identify the connection on which data has to be sent, and then encrypt and MAC protect the data using DTLS. The resulting DTLS message that MSG_DATA carries may include application data. The node then sends the DTLS message of the fourth type to the peer node. In response, the peer node identifies the DTLS connection based on connection ID in the header. The DTLS connection may be used to perform a MAC check and then to decrypt the application data message.

In an example, initiator node 102 may send DTLS message of n types to responder node 104. DTLS message of n types may include a header comprising fields similar to the fields present in the header of DTLS message of the first type. In an example, DTLS message of n types may be used for different purposes.

In an example, DTLS message of the first type, DTLS message of the second type, DTLS message of the third type, DTLS message of the fourth type, and/or DTLS message of n type may be sent over a common socket on initiator node 102 for establishing the DTLS connection with responder node 104. The subsequent messages (for example, DTLS message of the fourth type) may also be sent via same socket on initiator node 102. As mentioned earlier, multiple DTLS connections may be established between initiator node 102 and responder node 104. In an example, the messages exchanged between initiator node 102 and responder node 104 for these additional DTLS connections may also be sent over same socket on initiator node 102. Thus, multiple DTLS connections may be multiplexed on same socket. In an example, the socket may include a User Datagram Protocol (UDP) socket. In an example, a connection ID based on the message type may be used to multiplex and de-multiplex multiple connections (or to identify the connection).

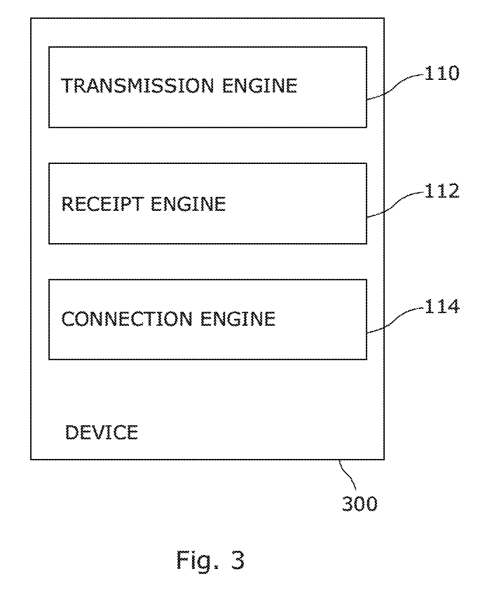

FIG. 3 is a block diagram of an example device 300 for establishing a DTLS connection between nodes in a cluster. In an example, device 300 may be analogous to node 102 or 104 of FIG. 1, in which like reference numerals correspond to the same or similar, though perhaps not identical, components. For the sake of brevity, components or reference numerals of FIG. 3 having a same or similarly described function in FIG. 1 are not being described in detail in connection with FIG. 3. Said components or reference numerals may be considered alike.

In an example, device 300 may include a transmission engine 110, a receipt engine 112, and a connection engine 114.

In an example, transmission engine 110 may send, over a UDP socket, a Datagram Transport Layer Security (DTLS) message of a first type to a second device in a cluster. The DTLS message of the first type may comprise a header. In an example, the header may include a message type field to identify a message type, a flag field to identify a message sender and a message category, an initiator connection ID field to identify a connection ID allocated by the device, and a responder connection ID field to identify a connection ID allocated by the second device. In the DTLS message of the first type the message type may represent a connection initiation request message, the initiator connection ID field may include a connection ID allocated by the device, the responder connection ID field may be set to zero, and the flag field may identify the device as the message sender.

In response, receipt engine 112 may receive, from the second device, an initiation response message comprising a header with fields similar to the fields of the header in the DTLS message of the first type. In the initiation response message, the responder connection ID field may include a connection ID allocated by the second device. The flag field may identify the second device as the message sender and a response message as the message category.

Transmission engine 110 may send, over the same UDP socket, a DTLS message of a second type to the second device. The DTLS message of the second type may comprise a header with fields similar to the fields of the header in the DTLS message of the first type. In the DTLS message of the second type, the message type may represent a connection negotiation message, the initiator connection ID field may include the connection ID allocated by the device, and the responder connection ID field may include the connection ID allocated by the second device.

In response, receipt engine 112 may receive, from the second device, a negotiation response message comprising a header with fields similar to the fields of the header in the DTLS message of the first type. In the negotiation response message, the flag field may identify the second device as the message sender and a response message as the message category. Connection engine 114 may establish a DTLS connection between the device and the second device.

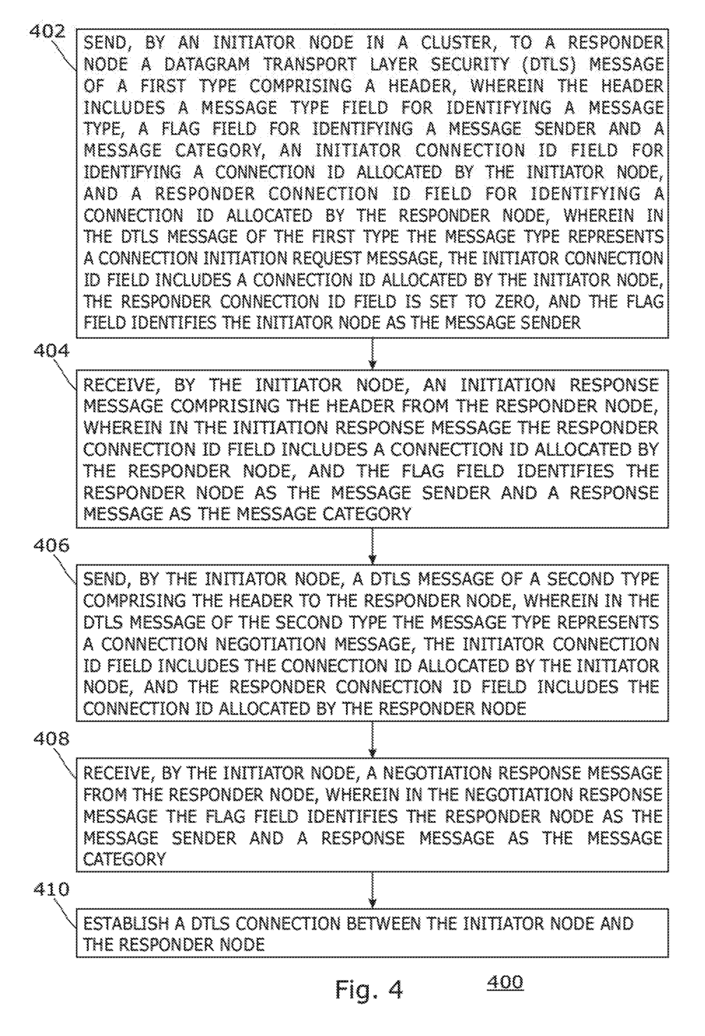

FIG. 4 is a block diagram of an example method 400 of establishing a DTLS connection between nodes in a cluster. The method 500, which is described below, may be executed on a node such as node 102 or 104 of FIG. 1. However, other devices may be used as well.

At block 402, an initiator node (for example, 102) in a cluster may send a Datagram Transport Layer Security (DTLS) message of a first type to a responder node (for example, 104) in the cluster. The DTLS message of the first type may include a header comprising: a message type field for identifying a message type, a flag field for identifying a message sender and a message category, an initiator connection ID field for identifying a connection ID allocated by initiator node 102, and a responder connection ID field for identifying a connection ID allocated by responder node 104. In the DTLS message of the first type, the message type may represent a connection initiation request message, the initiator connection ID field may include a connection ID allocated by initiator node 102, the responder connection ID field may be set to zero, and the flag field may identify initiator node 102 as the message sender.

At block 404, in response, initiator node 102 may receive an initiation response message comprising the header from responder node 104. In the initiation response message, the responder connection ID field may include a connection ID allocated by responder node 104, and the flag field may identify responder node 104 as the message sender and a response message as the message category.

At block 406, initiator node 102 may send a DTLS message of a second type comprising the header to responder node 104. In the DTLS message of the second type, the message type may represent a connection negotiation message, the initiator connection ID field may include the connection ID allocated by initiator node 102, and the responder connection ID field may include the connection ID allocated by responder node 104.

At block 408, in response, initiator node 102 may receive a negotiation response message from responder node 104. In the negotiation response message, the flag field may identify responder node 104 as the message sender and a response message as the message category.

At block 410, a DTLS connection may be established between initiator node 102 and responder node 104.

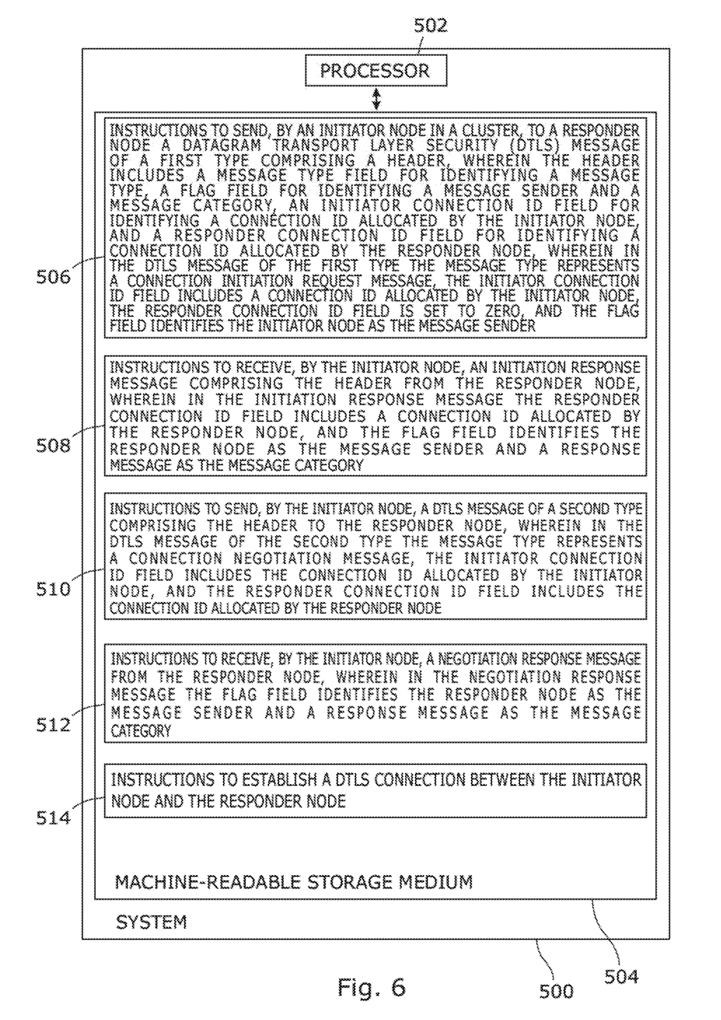

FIG. 5 is a block diagram of an example system 500 including instructions in a machine-readable storage medium for establishing a DTLS connection between nodes in a cluster.

System 500 includes a processor 502 and a machine-readable storage medium 504 communicatively coupled through a system bus. Processor 502 may be any type of Central Processing Unit (CPU), microprocessor, or processing logic that interprets and executes machine-readable instructions stored in machine-readable storage medium 504. Machine-readable storage medium 504 may be a random access memory (RAM) or another type of dynamic storage device that may store information and machine-readable instructions that may be executed by processor 502. For example, machine-readable storage medium 504 may be Synchronous DRAM (SDRAM), Double Data Rate (DDR), Rambus DRAM (RDRAM), Rambus RAM, etc. or storage memory media such as a floppy disk, a hard disk, a CD-ROM, a DVD, a pen drive, and the like. In some examples, machine-readable storage medium 504 may be a non-transitory machine-readable medium. In some examples, machine-readable storage medium 504 may be remote but accessible to system 500.

Machine-readable storage medium 504 may store instructions 506, 508, 510, 512, and 514. In some examples, instructions 506 may be executed by processor 502 to send, by an initiator node (for example, 102) in a cluster, to a responder node (for example, 104) a DTLS message of a first type comprising a header. The header may include a message type field for identifying a message type, a flag field for identifying a message sender and a message category, an initiator connection ID field for identifying a connection ID allocated by initiator node 102, and a responder connection ID field for identifying a connection ID allocated by responder node 104. In the DTLS message of the first type the message type may represent a connection initiation request message, the initiator connection ID field may include a connection ID allocated by initiator node 102, the responder connection ID field may be set to zero, and the flag field may identify initiator node 102 as the message sender.

Instructions 508 may be executed by processor 502 to receive, by initiator node 102, an initiation response message from responder node 104. The initiation response message may comprise a header with fields similar to the fields of the header in the DTLS message of the first type. In the initiation response message the responder connection ID field may include a connection ID allocated by responder node 104. The flag field may identify responder node 104 as the message sender and a response message as the message category.

Instructions 510 may be executed by processor 502 to send, by initiator node 102, a DTLS message of a second type to responder node 104. The DTLS message of the second type may comprise a header with fields similar to the fields of the header in the DTLS message of the first type. In the DTLS message of the second type, the message type may represent a connection negotiation message, the initiator connection ID field may include the connection ID allocated by initiator node 102, and the responder connection ID field may include the connection ID allocated by responder node 104. The DTLS message of the first type and the DTLS message of the second type may be sent over a common socket on initiator node 102.

Instructions 512 may be executed by processor 502 to receive, by initiator node 102, a negotiation response message from responder node 104. The negotiation response message may comprise a header with fields similar to the fields of the header in the DTLS message of the first type. In the negotiation response message, the flag field may identify responder node 104 as the message sender and a response message as the message category. Instructions 512 may be executed by processor 502 to establish a DTLS connection between initiator node and responder node 104.

For the purpose of simplicity of explanation, the example method of FIG. 4 is shown as executing serially, however it is to be understood and appreciated that the present and other examples are not limited by the illustrated order. The example systems of FIGS. 1, 3, and 5, and method of FIG. 4 may be implemented in the form of a computer program product including computer-executable instructions, such as program code, which may be run on any suitable computing device in conjunction with a suitable operating system (for example, Microsoft Windows, Linux, UNIX, and the like). Embodiments within the scope of the present solution may also include program products comprising non-transitory computer-readable media for carrying or having computer-executable instructions or data structures stored thereon. Such computer-readable media can be any available media that can be accessed by a general purpose or special purpose computer. By way of example, such computer-readable media can comprise RAM, ROM, EPROM, EEPROM, CD-ROM, magnetic disk storage or other storage devices, or any other medium which can be used to carry or store desired program code in the form of computer-executable instructions and which can be accessed by a general purpose or special purpose computer. The computer readable instructions can also be accessed from memory and executed by a processor.

It should be understood that the above-described examples of the present solution is for the purpose of illustration only. Although the solution has been described in conjunction with a specific embodiment thereof, numerous modifications may be possible without materially departing from the teachings and advantages of the subject matter described herein. Other substitutions, modifications and changes may be made without departing from the spirit of the present solution. All of the features disclosed in this specification (including any accompanying claims, abstract and drawings), and/or all of the steps of any method or process so disclosed, may be combined in any combination, except combinations where at least some of such features and/or steps are mutually exclusive.

1. A method comprising:
sending, by an initiator node in a cluster, to a responder node a Datagram Transport Layer Security (DTLS) message of a first type comprising a header, wherein the header includes a message type field for identifying a message type, a flag field for identifying a message sender and a message category, an initiator connection ID field for identifying a connection ID allocated by the initiator node, and a responder connection ID field for identifying a connection ID allocated by the responder node, wherein in the DTLS message of the first type the message type represents a connection initiation request message, the initiator connection ID field includes a connection ID allocated by the initiator node, the responder connection ID field is set to zero, and the flag field identifies the initiator node as the message sender;
receiving, by the initiator node, an initiation response message comprising the header from the responder node, wherein in the initiation response message the responder connection ID field includes a connection ID allocated by the responder node, and the flag field identifies the responder node as the message sender and a response message as the message category;
sending, by the initiator node, a DTLS message of a second type comprising the header to the responder node, wherein in the DTLS message of the second type the message type represents a connection negotiation message, the initiator connection ID field includes the connection ID allocated by the initiator node, and the responder connection ID field includes the connection ID allocated by the responder node;
receiving, by the initiator node, a negotiation response message from the responder node, wherein in the negotiation response message the flag field identifies the responder node as the message sender and a response message as the message category; and
establishing a DTLS connection between the initiator node and the responder node.

2. The method of claim 1, wherein the DTLS message of the first type and the DTLS message of the second type are sent over a common socket on the initiator node.

3. The method of claim 2, wherein the socket includes a User Datagram Protocol (UDP) socket.

4. The method of claim 1, further comprising:
sending, by the initiator node, a DTLS message of a third type comprising the header, wherein in the DTLS message of the third type the message type represents a connection notification message.

5. The method of claim 4, wherein the DTLS message of the third type notifies closing of the DTLS connection to the responder node.

6. The method of claim 1, further comprising:
sending, by the initiator node, a DTLS message of a fourth type, wherein in the DTLS message of the fourth type the message type represents a data message.

7. The method of claim 6, wherein the DTLS message of the fourth type sends data to the responder node.

8. A device comprising:
a transmission engine to send over a UDP socket, to a second device in a cluster, a Datagram Transport Layer Security (DTLS) message of a first type comprising a header, wherein the header includes a message type field to identify a message type, a flag field to identify a message sender and a message category, an initiator connection ID field to identify a connection ID allocated by the device, and a responder connection ID field to identify a connection ID allocated by the second device, wherein in the DTLS message of the first type the message type represents a connection initiation request message, the initiator connection ID field includes a connection ID allocated by the device, the responder connection ID field is set to zero, and the flag field identifies the device as the message sender;
a receipt engine to receive an initiation response message comprising the header from the second device, wherein in the initiation response message the responder connection ID field includes a connection ID allocated by the second device, and the flag field identifies the second device as the message sender and a response message as the message category;
the transmission engine to send, over the UDP socket, a DTLS message of a second type comprising the header to the second device, wherein in the DTLS message of the second type the message type represents a connection negotiation message, the initiator connection ID field includes the connection ID allocated by the device, and the responder connection ID field includes the connection ID allocated by the second device;
the receipt engine to receive a negotiation response message from the second device, wherein in the negotiation response message the flag field identifies the second device as the message sender and a response message as the message category; and
a connection engine to establish a DTLS connection between the device and the second device.

9. The device of claim 8, wherein the connection engine is to establish a second DTLS connection between the device and the second device.

10. The device of claim 9, wherein the second DTLS connection is established via the UDP socket.

11. The device of claim 8, wherein, in the header:
the responder connection ID field follows the initiator connection ID field;
the initiator connection ID field follows the flag field; and
the flag filed follows the message type field.

12. The device of claim 11, wherein, in the header, the message type field follows the protocol version field.

13. A non-transitory machine-readable storage medium comprising instructions, the instructions executable by a processor to:
send, by an initiator node in a cluster, to a responder node a Datagram Transport Layer Security (DTLS) message of a first type comprising a header, wherein the header includes a message type field for identifying a message type, a flag field for identifying a message sender and a message category, an initiator connection ID field for identifying a connection ID allocated by the initiator node, and a responder connection ID field for identifying a connection ID allocated by the responder node, wherein in the DTLS message of the first type the message type represents a connection initiation request message, the initiator connection ID field includes a connection ID allocated by the initiator node, the responder connection ID field is set to zero, and the flag field identifies the initiator node as the message sender;
receive, by the initiator node, an initiation response message comprising the header from the responder node, wherein in the initiation response message the responder connection ID field includes a connection ID allocated by the responder node, and the flag field identifies the responder node as the message sender and a response message as the message category;
send, by the initiator node, a DTLS message of a second type comprising the header to the responder node, wherein in the DTLS message of the second type the message type represents a connection negotiation message, the initiator connection ID field includes the connection ID allocated by the initiator node, and the responder connection ID field includes the connection ID allocated by the responder node, wherein the DTLS message of the first type and the DTLS message of the second type are sent over a common socket on the initiator node;
receive, by the initiator node, a negotiation response message from the responder node, wherein in the negotiation response message the flag field identifies the responder node as the message sender and a response message as the message category; and
establish a DTLS connection between the initiator node and the responder node.

14. The storage medium of claim 13, wherein the responder node is present in the cluster.

15. The storage medium of claim 13, wherein the DTLS message of the second type is a handshake message specified by DTLS protocol.

16. The storage medium of claim 13, further comprising instructions to:
identify, by the initiator node, the connection ID allocated by the responder node from the responder connection ID field.

17. The storage medium of claim 13, further comprising instructions to:
append the header to the DTLS message of the first type.

18. The storage medium of claim 13, further comprising instructions to:
store, by the initiator node, the connection ID allocated by the responder node.

19. The storage medium of claim 13, wherein the initiator node and the responder node are nodes in a wireless network.

20. The storage medium of claim 13, wherein the initiator node and the responder node are Wireless Access Points (WAPs).
